(19) United States
(12) Patent Application Publication
(10) Pub. No.: US 2019/0295260 A1
(43) Pub. Date: Sep. 26, 2019

(54) METHOD AND SYSTEM FOR IMAGE SEGMENTATION USING CONTROLLED FEEDBACK

(71) Applicant: Konica Minolta Laboratory U.S.A., Inc., San Mateo, CA (US)

(72) Inventors: Sachin Mehta, Seattle, WA (US); Haisong Gu, San Mateo, CA (US)

(73) Assignee: Konica Minolta Laboratory U.S.A., Inc., San Mateo, CA (US)

(21) Appl. No.: 16/345,894

(22) PCT Filed: Oct. 27, 2017
(86) PCT No.: PCT/US2017/058726

§ 371 Date: Apr. 29, 2019

Related U.S. Application Data
(60) Provisional application No. 62/415,418, filed on Oct. 31, 2016.

(51) Int. Cl. G06T 7/11; G06K 9/32; G06N 3/08; G06T 7/187

(52) U.S. Cl. CPC G06T 7/11; G06T 7/187; G06N 3/08; G06K 9/3241

(57) ABSTRACT

A method, a computer readable recording medium, and a system are disclosed for image segmentation using controlled feedback in a neural network. The method includes extracting image data from an image; performing one or more semantic segmentations on the extracted image data; introducing one or more classifiers to each of the one or more semantic segmentations, each of the one or more classifiers assigning a probability to one or more classes of objects within the image; and generating a segmentation mask from the one or more semantic segmentations.

### CROSS-REFERENCES TO RELATED APPLICATIONS

This application claims priority to U.S. Provisional Application No. 62/415,418 filed on Oct. 31, 2016, the entire content of which is incorporated herein by reference.

### FIELD OF THE INVENTION

The present disclosure relates to a method and system for image segmentation using controlled feedback, and more particularly, to a neural network-based method and system for image segmentation with controlled feedback that allows segmented images with unbalanced class information and also allow the network to initialize the weights properly.

### BACKGROUND OF THE INVENTION

Detecting, segmenting, and classifying objects, for example, in medical images can be important for detection and diagnosis of diseases. Deep neural networks (NNs), including convolutional neural networks (CNN), as well as other types of multilevel neural networks, are an existing method for improved feature learning, classification, and detection.

Pixel-wise labeling or semantic segmentation is a process of assigning each pixel a label of the class to which they belong. For example, a segmented image will have the same labels for all the pixels that correspond, for example, to human, in an image. However, one problem with current convolution neural networks is that they need weight initialization. In addition, weights can be initialized randomly, however, it can take a long time for the weights to converge.

For example, methods have been proposed that take into account class imbalance information at the last stage (loss computation) of the network, however, the methods still require a long time for the network to converge. In addition, there has been work to strengthen the weights of convolution layer by domain transfer knowledge. However, these methods rely on the output of the pre-trained network, and generally tend to strengthen the edge information.

### SUMMARY OF THE INVENTION

In accordance with an exemplary embodiment, a system and method are disclosed, which are capable of strengthening the weights of edges as well as entire region. Further, the controlled nature of the disclosed method allows the model to strengthen the weights of a particular class which is not possible with techniques such as domain transfer knowledge, for example, edges detected via domain transform based models are for an entire image, and since the system may not be able to classify which edge belongs to which object and hence, makes it difficult to apply for a particular class.

For example, accurate cell body extraction can greatly help to quantify cell features for further pathological analysis of cancer cells. In a practical scenario, for example, cell image data often has the following issues: a wide variety of appearances resulting from different tissue types, block cuttings, staining process, equipment and hospitals, and cell image data is gradually collected over time and the collected data is usually unbalanced, for example, some types of cell images are greater than other types of cell images.

In this disclosure, a method is disclosed to provide feedback early in the network so that network can initialize with strong weights (or probabilities) and converge earlier, thus reducing the training time and can improve learning, for example, for extraction or identification of cell bodies.

In consideration of the above issues, it would be desirable to have a system and method to control the weights of the neural network by feedback. In accordance with an exemplary embodiment, the method and system emphasizes the weights that are important and de-emphasizes (or un-emphasizes) the weights that are less important. Emphasizing the weights (or probabilities) earlier in the process can help in initializing the network weights properly, and which can help the network to converge earlier and improve the learning of the network.

A method is disclosed for image segmentation using controlled feedback in a neural network, the method comprising: extracting image data from an image; performing one or more semantic segmentations on the extracted image data; introducing one or more classifiers to each of the one or more semantic segmentations, each of the one or more classifiers assigning a probability to one or more classes of objects within the image; and generating a segmentation mask from the one or more semantic segmentations.

A non-transitory computer readable recording medium stored with a computer readable program code for image segmentation using controlled feedback in a neural network is disclosed, the computer readable program code configured to execute a process comprising: extracting image data from an image; performing one or more semantic segmentations on the extracted image data; introducing one or more classifiers to each of the one or more semantic segmentations, each of the one or more classifiers assigning a probability to one or more classes of objects within the image; and generating a segmentation mask from the one or more semantic segmentations.

A system is disclosed for image segmentation using controlled feedback in a neural network, the system comprising: a processor; and a memory storing instructions that, when executed, cause the system to: extract image data from an image; perform one or more semantic segmentations on the extracted image data; introduce one or more classifiers to each of the one or more semantic segmentations, each of the one or more classifiers assigning a probability to one or more classes of objects within the image; and generate a segmentation mask from the one or more semantic segmentations.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an illustration of an encoder-decoder system for semantic segmentation in accordance with an exemplary embodiment.

FIG. 2 is another illustration of an encoder-decoder system for semantic segmentation in accordance with an exemplary embodiment.

FIG. 3 is an illustration of an encoder-decoder system for semantic segmentation in accordance with an exemplary embodiment with a cell region as a feedback.

FIG. 4 is an illustration of an encoder-decoder system for semantic segmentation in accordance with an exemplary embodiment with a cell boundary as a feedback.

FIG. 5 is an illustration of an encoder-decoder system for semantic segmentation in accordance with an exemplary embodiment during a testing phase with feedback.

FIG. 6 is an illustration of an encoder-decoder system for semantic segmentation in accordance with an exemplary embodiment with multiple image class regions as a feedback.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

In accordance with an exemplary embodiment, a method and system are disclosed, which can instruct (or tell) the convolution neural network that certain neurons are important and thus, emphasizes the weights corresponding to those neurons. For example, in accordance with an exemplary embodiment, the method and system allows the network to emphasize, de-emphasize, or un-change the weights of the network. For neural networks to converge, weight initialization can be a very important step and several methods have been proposed for weight initialization. Once the weights are initialized for different layers, data is passed through the network several times, so that network can converge. Usually, however, it takes a lot of time for a network to converge.

In accordance with an exemplary embodiment, a method and system are disclosed that instructs (or tells) the network that these are important neurons by means of feedback and thus emphasizes the weights of corresponding neurons. In addition, the controlled nature of the method as disclosed allows the model to strengthen the weights of a particular class, which is not possible, for example, with techniques such as domain transfer knowledge.

In cyclic learning, the networks currently can be trained in stages whereby a model is first or initially trained with the easy data and then fine-tuned using the difficult data. In addition to this type of learning, the method as disclosed allows the system or method to learn the network in cycles for same (data that can be easily learned) or different (data is difficult to learn) data. For example, the first 2 epochs (trainable encoders and/or trainable decoders) can be learned with feedback while the next, for example, 5 epochs (trainable encoders and/or trainable decoders) can be learned without feedback and so on until the network converges, which can help with the learning such that the model can find a local minima relatively early.

In accordance with an exemplary embodiment, due to the controlled nature, the system and method as disclosed can be used for semi-supervised or un-supervised learning. In accordance with an exemplary embodiment, in a prediction phase, the method and system can use previous results as the masks to conduct the feedbacks, for example, to periodically improve a current model.

For example, cell images are unbalanced class images where background information is generally greater (or more prevalent) in comparison to foreground (such as cell). In accordance with an exemplary embodiment, for example, the method as disclosed can emphasize the weights of cells while de-emphasizing, for example, the weights of the background.

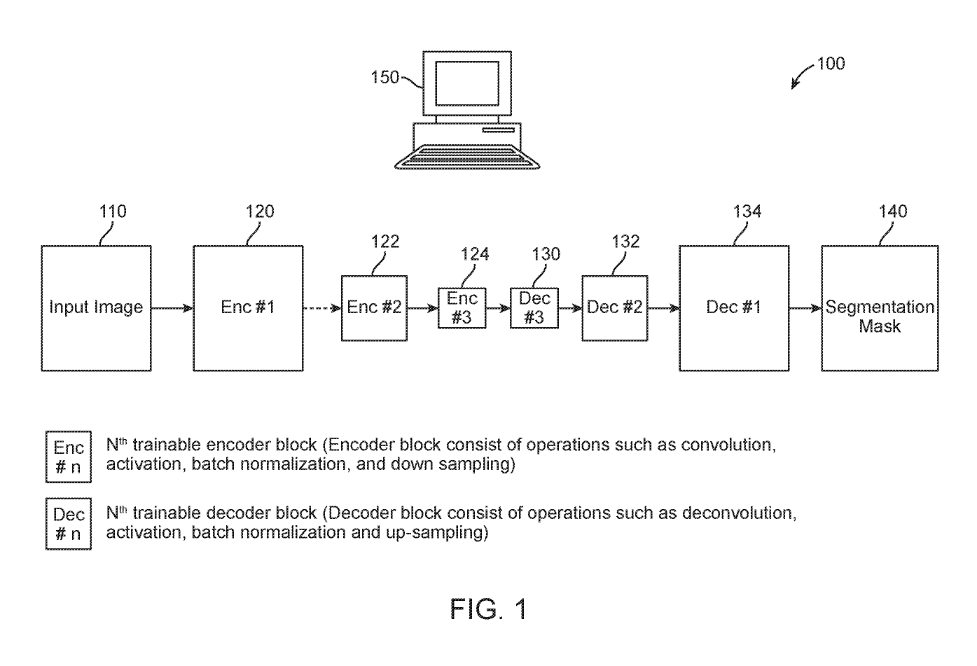

FIG. 1 is an illustration of an encoder-decoder system 100 for semantic segmentation in accordance with an exemplary embodiment without feedback. As shown in FIG. 1, the encoder-decoder system 100 includes an input image 110, a plurality of trainable encoder blocks 120, 122, 124, a plurality of trainable decoder blocks 130, 132, 134, and a segmentation mask 140. In accordance with an exemplary embodiment, the plurality of encoder blocks 120, 122, 124, or non-linear processing layers, can consist of operations such as convolution, activation, batch normalization, and down sampling. The corresponding plurality of decoder blocks 130, 132, 134 can consist of operations such as deconvolution, activation, batch normalization, and up-sampling.

In accordance with an exemplary embodiment, the plurality of trainable encoder blocks 120, 122, 124, and the plurality of trainable decoder blocks 130, 132, 134, can be hosted on a computer system or processing unit 150, which can include a processor or central processing unit (CPU) and one or more memories for storing software programs and data. The processor or CPU carries out the instructions of a computer program, which operates and/or controls at least a portion of the functionality of the computer system or processing unit 150. The computer system or processing unit 150 can also include an input unit, a display unit or graphical user interface (GUI), and a network interface (I/F), which is connected to a network communication (or network). The computer system or processing unit 150 can also include an operating system (OS), which manages the computer hardware and provides common services for efficient execution of various software programs. For example, some embodiments may include additional or fewer computer system or processing unit 150, services, and/or networks, and may implement various functionality locally or remotely on other computing devices (not shown). Further, various entities may be integrated into to a single computing system or processing unit 150 or distributed across additional computing devices or systems 150.

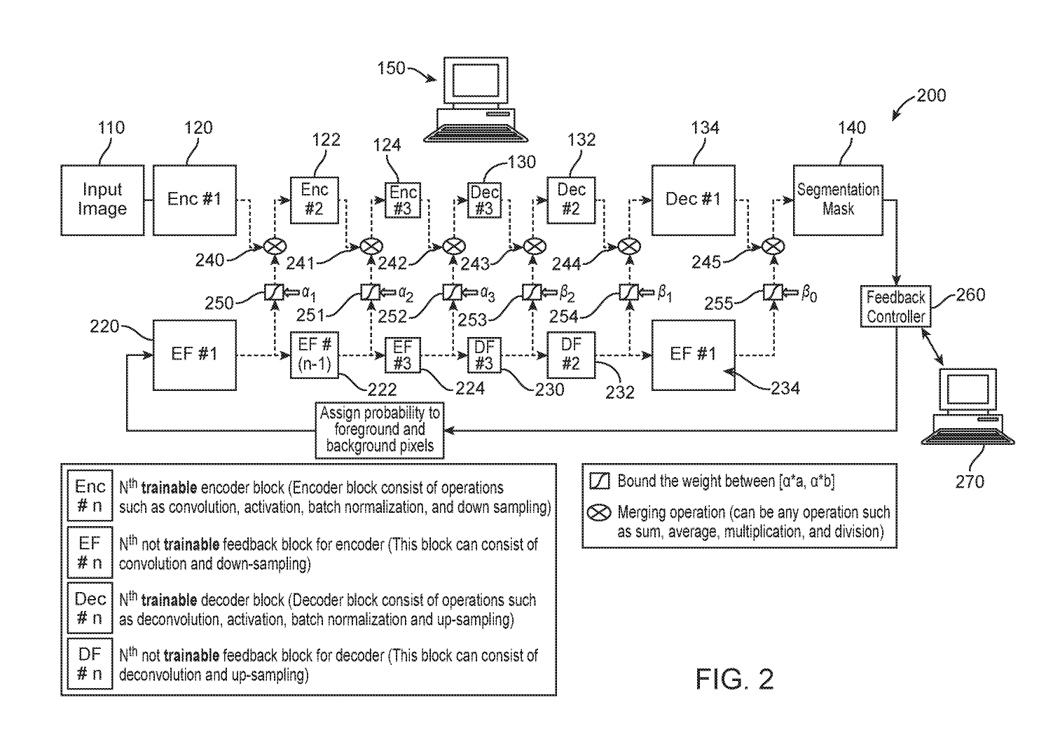

FIG. 2 is an illustration of an encoder-decoder system 200 for semantic segmentation in accordance with an exemplary embodiment. As shown in FIG. 2, the system 200 can include the input image 110, the plurality of trainable encoder blocks 120, 122, 124, the plurality of trainable decoder blocks 130, 132, 134, the segmentation mask 140, a plurality of not trainable feedback blocks for the encoder 220, 222, 224, a plurality of not trainable feedback blocks for the decoder 230, 232, 234, a plurality of weight functions (or bound the weight between (α*a, α*b)) 240, 241, 242, 243, 244, 245, and a plurality of merging operations 250, 251, 252, 253, 254, 255. In accordance with an exemplary embodiment, the plurality of not trainable encoder blocks 220, 222, 224, can consist of operations, for example, such as convolution and down sampling. The corresponding plurality of not trainable decoder blocks 230, 232, 234 can consist of operations, for example, such as deconvolution and up-sampling.

In accordance with an exemplary embodiment, the system 200 also includes a feedback controller 260. The feedback controller 260 can be configured to change or adjust the respective weights of one or more classes by assigning a weight, to each of the one or more classes within the image 110. In accordance with an exemplary embodiment, the plurality of weight functions 240, 241, 242, 243, 244, 245 can assign a probability to each of the plurality of pixels of the input image 110, if each of the plurality of pixels belongs to a certain class of pixels. For example, in cell detection, the classification weights of the foreground, which can include cell regions or boundaries between cell regions can be greater than the classification weights of the background, and, for example, a stain color. In addition, the feedback controller 260 can be “ON”, or alternatively, can be “OFF”, such that each of the classification weights is equal or set to set number, for example, one (1).

In accordance with an exemplary embodiment, the feedback controller 260 can be hosted on a computer system or processing unit 150 as shown in FIG. 1, or alternatively, can be hosted on a separate computer system or processing unit 270. For example, the separate computer system or processing unit 270 can include a processor or central processing unit (CPU) and one or more memories for storing software programs and data. The processor or CPU carries out the instructions of a computer program, which operates and/or controls at least a portion of the functionality of the computer system or processing unit 150. The computer system or processing unit 270 can also include an input unit, a display unit or graphical user interface (GUI) for imputing data, and a network interface (I/F), which is connected to a network communication (or network). The computer system or processing unit 270 can also include an operating system (OS), which manages the computer hardware and provides common services for efficient execution of various software programs. For example, some embodiments may include additional or fewer computer system or processing unit 150, 270, and/or networks, and may implement various functionality locally or remotely on other computing devices (not shown). Further, various entities may be integrated into a single computing system or processing unit 150, 270 or distributed across additional computing devices or systems 150, 270. In accordance with exemplary embodiment, for example, the display unit or GUI can be used to input the image 110 into the system or processing unit 150, 270, to visualize the segmentation mask 140, or input information pertaining to classes via a feedback map.

In accordance with an exemplary embodiment, the system and method for semantic segmentation can include a training phase having an input training data set denoted by S={(Xₙ; Yₙ), n=1 . . . N}, where sample Xₙ={xⱼ⁽ⁿ⁾, j=1, . . . |Xₙ|} denotes the raw input image and Yₙ={yⱼ⁽ⁿ⁾, j=1, . . . |Xₙ|}, yⱼ⁽ⁿ⁾ϵ{0,1} denotes the corresponding ground truth label for image Xₙ. The subscript n for notational simplicity has been subsequently dropped. In accordance with an exemplary embodiment, Wₑ and W_{d} denotes the layer parameters for the encoder and decoder respectively.

In accordance with an exemplary embodiment, a network is disclosed that can be configured to emphasize the weights for certain (or all, excluding background) classes and de-emphasize (or remain same as initialized) for other classes. For example, in accordance with an exemplary embodiment, to emphasize important class information over other information such as background, a class selection weight γ can be introduced on a per class basis. A feedback map is then generated as Y_{f}={γ_{c}yⱼ⁽ⁿ⁾, j=1, . . . |Xₙ|}, yⱼ⁽ⁿ⁾ϵ{0,1}, cϵ{0, C} where C denotes the number of classes. In accordance with an exemplary embodiment, a feedback map is then passed through the feedback network to generate weights wₑ and w_{d}. The weights of feedback layers can be represented as (wₑ¹, wₑ^{k}, w_{α}¹, . . . , w_{d}¹). In accordance with an exemplary embodiment, the value of w can be greater than 1, however, if the value of w is greater than 1, the value may result in the network not converging to a local minima. In accordance with an exemplary embodiment, the weights of feedback network layers can be updated as:

$$f ( w ) = max ( a , \frac{b}{( 1 + {e}^{- 1} )} )$$

where w_{(.)} represents the encoder and decoder weights for the feedback network, respectively

In accordance with an exemplary embodiment, the weight emphasis function or merging operation for the encoder and decoder can be defined as:

ε(Wₑ,wₑ)=Wₑ*αwₑ

ε(W_{d},w_{d})=W_{d}*βw_{d}

where * can be any element wise operation (addition, multiplication, subtraction, etc.), α and β are scaling parameters for the encoding and decoding stages respectively.

In accordance with exemplary embodiment, each of the plurality of weight functions 240, 241, 242, 243, 244, 245 for the feedback network 220, 222, 224, 230, 232, 234 as disclosed herein can be the same for each of the feedback networks 220, 222, 224, 230, 232, 234, or alternatively, one or more of the plurality of weight functions 240, 241, 242, 243, 244, 245 as disclosed herein can be different. For example, as shown in FIG. 2, the first 2 feedback networks (or epochs) 220, 222 can be learned with feedback while next, for example, 4 feedback networks (or epochs) 224, 230, 232, 234 can be learned without feedback and so on until the network converges, which can help with the learning such that the model can find the local minima earlier.

In accordance with an exemplary embodiment, in image-to-image training, for example, the loss function can be computed over all pixels in a training image X and ground truth label image Y. For example, during the testing phase, given image X, the segmentation predictions were obtained, for example, as:

Y=CCNNSS(X,(Wₑ,W_{d}))

In accordance with an exemplary embodiment, a number of object classes can be different. For example, in cell images, background pixels can be more prevalent in comparison to boundary and cell pixels. Accordingly, in the system and method as disclosed, emphasizing the weights of different classes, for example, cell boundaries or cell regions over background pixels can be performed.

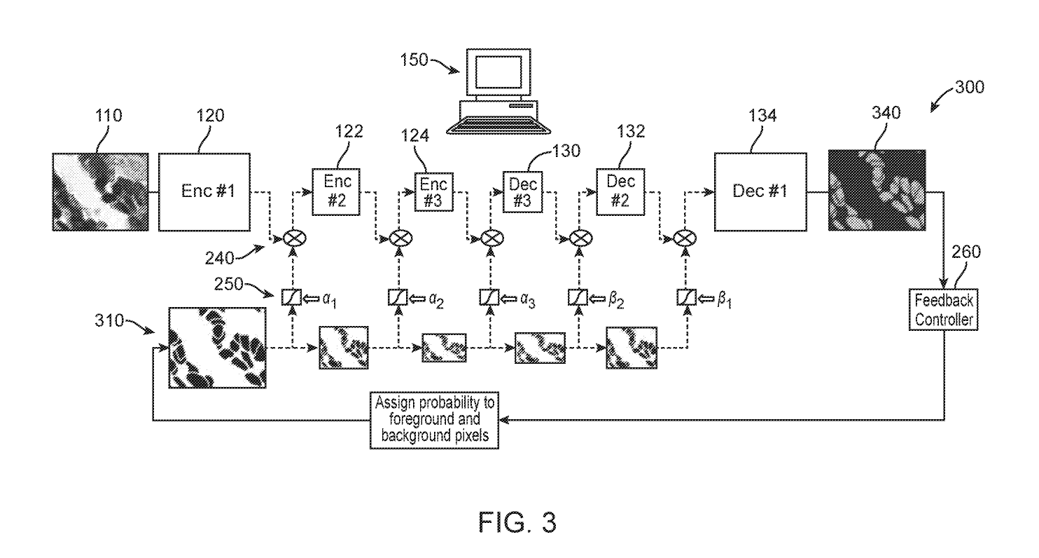

FIG. 3 is an illustration of an encoder-decoder system 300 for semantic segmentation in accordance with an exemplary embodiment with a cell region 310 used as feedback. As shown in FIG. 3, for example, the system 300 can be configured using the feedback controller 260 to emphasize a cell region (or cell region mask) 310 on an input image 110 from an analysis, for example, for cancer cells, by assigning a probability to each of the foreground pixels and background pixels, which can likely represent, for example, cell regions and non-cell regions, respectively.

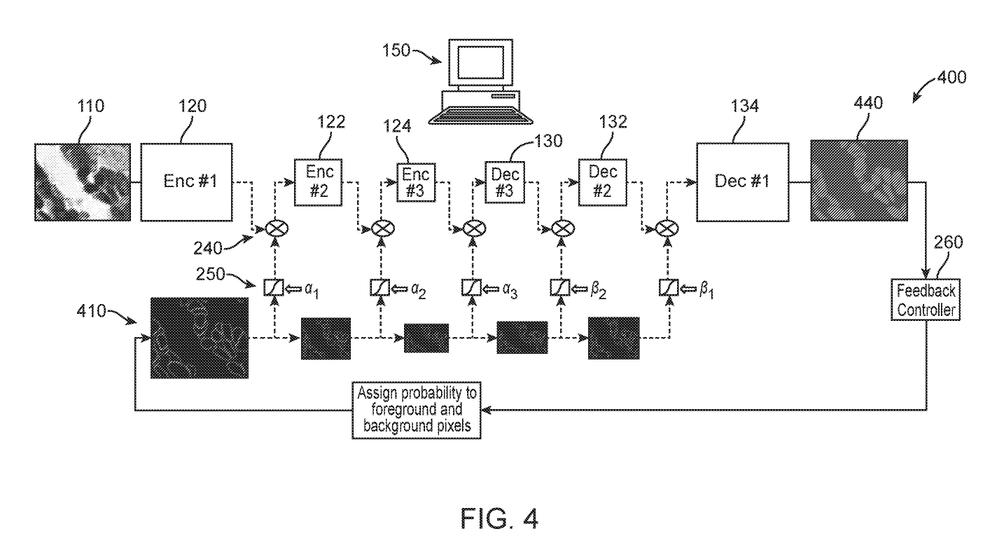

FIG. 4 is an illustration of an encoder-decoder system for semantic segmentation in accordance with an exemplary embodiment with a cell boundary 410 used as feedback. As shown in FIG. 4, for example, the system 400 can be configured using the feedback controller 260 to emphasize a cell boundary (or cell boundary mask) 410 on an input image 110 from an analysis, for example, for cancer cells, by assigning a probability to each of the foreground and background pixels, which can likely represent, for example, cell boundaries and non-cell boundaries or regions.

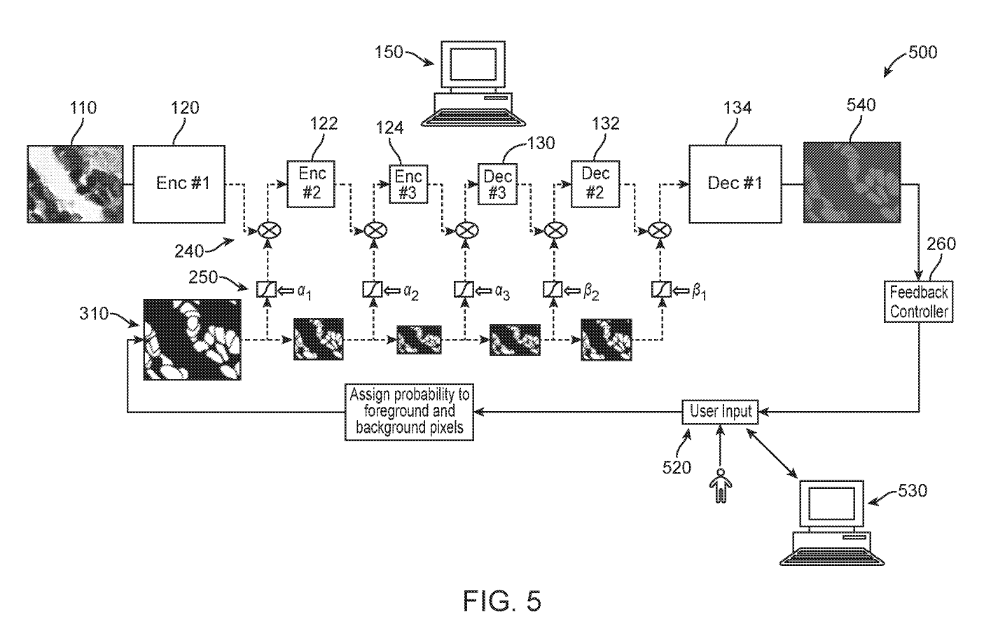

FIG. 5 is an illustration of an encoder-decoder system 500 for semantic segmentation in accordance with an exemplary embodiment during, for example, a testing phase with feedback. For example, manually annotating images can be difficult and time consuming. In accordance with an exemplary embodiment, data available for training a neural network for medical data is not as large as general images (in general, medical image datasets contain a few thousand images, while general image datasets can contain several thousand images). Thus, generating good segmentation results can be difficult.

In accordance with an exemplary embodiment, due to the feedback nature of the method as disclosed, the method and system 500 can allow the network to learn even in case of testing (or training) time. For example, the method as disclosed can give the flexibility that the user can discard the incorrect labels or correct them and then feed the output to the network for fine-tuning the weights via user input 520. The user input 520 can be input via the computer system or processing unit 150, 270, which processes the image 110, or alternatively, can be performed by a remote computer system or processing unit 530. In accordance with an exemplary embodiment, the remote computer system or processing unit 530 can be in communication computer system or processing unit 150 via a communication network.

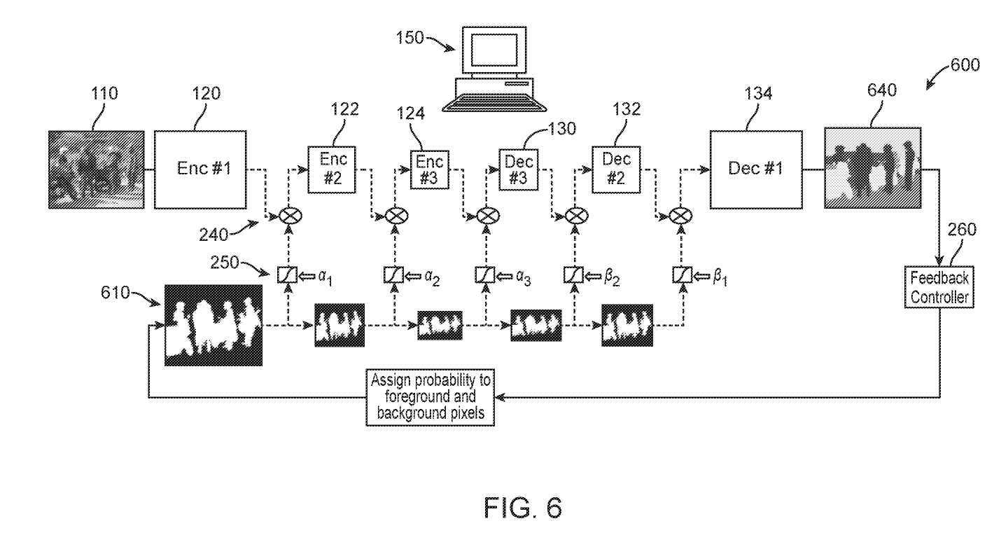

FIG. 6 is an illustration of an encoder-decoder system 600 for semantic segmentation in accordance with an exemplary embodiment with multiple image class regions as a feedback. As shown in FIG. 6, the system and methods as disclosed can also be used for general images 640, containing or illustrating, for example, people, cars, motorcycles, trees, etc. In FIG. 6, the input image 610 can contain multiple classes, such that, for example, the system and method as disclosed herein can be applied to emphasize the weights of a human and/or motorbike instead of emphasizing all other classes such as trees, road, etc. In accordance with an exemplary embodiment, for example, as shown in FIG. 6, the feedback channel can treat a human and/or a motorbike as a foreground class and generate a mask 610 from the human and/or motorbike.

In accordance with an exemplary embodiment, a non-transitory computer readable recording medium stored with a computer readable program code for image segmentation using controlled feedback in a neural network is disclosed. The computer readable program code configured to execute a process comprising: extracting image data from an image; performing one or more semantic segmentations on the extracted image data; introducing one or more classifiers to each of the one or more semantic segmentations, each of the one or more classifiers assigning a probability to one or more classes of objects within the image; and generating a segmentation mask from the one or more semantic segmentations.

The non-transitory computer readable medium may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if an embodiment of the present invention is a combination of software and hardware, it does not deviate from the concept of the invention at all. The present invention may be implemented such that its software part has been written onto a recording medium in advance and will be read as required in operation.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for image segmentation using controlled feedback in a neural network, the method comprising:
extracting image data from an image;
performing one or more semantic segmentations on the extracted image data;
introducing one or more classifiers to each of the one or more semantic segmentations, each of the one or more classifiers assigning a probability to one or more classes of objects within the image; and
generating a segmentation mask from the one or more semantic segmentations.

2. The method of claim 1, comprising:
assigning the one or more classifiers to each of the one or more semantic segmentations as a feedback.

3. The method of claim 1, comprising:
manually annotating at least a portion of the feedback that is incorrectly labeled.

4. The method of claim 1, wherein the one or more classifiers are same for each of the one or more semantic segmentations.

5. The method of claim 1, wherein at least one of the one or more classifiers are different in at least one of the one or more semantic segmentations.

6. The method of claim 1, wherein the one or more semantic segmentations are performed with a trainable encoder block configured to perform an operating consisting of convolution, activation, batch normalization, and down sampling, or a trainable decoder block configured to perform an operation consisting of deconvolution, activation, batch normalization, and up-sampling.

7. The method of claim 6, wherein the one or more classifiers are introduced via a not trainable feedback block for the trainable encoder block, the not trainable feedback block for the encoder block configured to perform an operation consisting of convolution and down-sampling, or a not trainable feedback block for the trainable decoder block, the not trainable feedback for the decoder block configured to perform an operation consisting of deconvolution and up-sampling.

8. The method of claim 1, comprising:
introducing the one or more classifiers by a merging operating.

9. The method of claim 1, wherein the one or more classifiers pertain to two or more classes of objects within the image.

10. The method of claim 1, wherein the assigning of a probability to the one or more classes of objects within the image comprises:
emphasizing one or more classes of objects in the image; and/or
deemphasizing one or more classes of objects in the image.

11. A non-transitory computer readable recording medium stored with a computer readable program code for image segmentation using controlled feedback in a neural network, the computer readable program code configured to execute a process comprising:
extracting image data from an image;
performing one or more semantic segmentations on the extracted image data;
introducing one or more classifiers to each of the one or more semantic segmentations, each of the one or more classifiers assigning a probability to one or more classes of objects within the image; and
generating a segmentation mask from the one or more semantic segmentations.

12. The computer readable recording medium of claim 11, comprising:
assigning the one or more classifiers to each of the one or more semantic segmentations as a feedback.

13. The computer readable recording medium of claim 11,
wherein the one or more classifiers are same for each of the one or more semantic segmentations; and/or
wherein at least one of the one or more classifiers are different in at least one of the one or more semantic segmentations.

14. The computer readable recording medium of claim 11,
wherein the one or more semantic segmentations are performed with a trainable encoder block configured to perform an operating consisting of convolution, activation, batch normalization, and down sampling, or a trainable decoder block configured to perform an operation consisting of deconvolution, activation, batch normalization, and up-sampling; and
wherein the one or more classifiers are introduced via a not trainable feedback block for the trainable encoder block, the not trainable feedback block for the encoder block configured to perform an operation consisting of convolution and down-sampling, or a not trainable feedback block for the trainable decoder block, the not trainable feedback for the decoder block configured to perform an operation consisting of deconvolution and up-sampling.

15. The computer readable recording medium of claim 11, comprising:
introducing the one or more classifiers by a merging operating.

16. A system for image segmentation using controlled feedback in a neural network, the system comprising:
a processor; and
a memory storing instructions that, when executed, cause the system to:
extract image data from an image;
perform one or more semantic segmentations on the extracted image data;
introduce one or more classifiers to each of the one or more semantic segmentations, each of the one or more classifiers assigning a probability to one or more classes of objects within the image; and
generate a segmentation mask from the one or more semantic segmentations.

17. The system of claim 16, comprising:
assigning the one or more classifiers to each of the one or more semantic segmentations as a feedback.

18. The system of claim 16,
wherein the one or more classifiers are same for each of the one or more semantic segmentations; and/or
wherein at least one of the one or more classifiers are different in at least one of the one or more semantic segmentations.

19. The system of claim 16,
wherein the one or more semantic segmentations are performed with a trainable encoder block configured to perform an operating consisting of convolution, activation, batch normalization, and down sampling, or a trainable decoder block configured to perform an operation consisting of deconvolution, activation, batch normalization, and up-sampling; and
wherein the one or more classifiers are introduced via a not trainable feedback block for the trainable encoder block, the not trainable feedback block for the encoder block configured to perform an operation consisting of convolution and down-sampling, or a not trainable feedback block for the trainable decoder block, the not trainable feedback for the decoder block configured to perform an operation consisting of deconvolution and up-sampling.

20. The system of claim 16, comprising:
introducing the one or more classifiers by a merging operating.
